(19) United States
(12) Patent Application Publication
(10) Pub. No.: US 2013/0054463 A1
(43) Pub. Date: Feb. 28, 2013

(54) Dynamic Level Assessment

(71) Applicants: Ray Olson, Half Moon Bay, CA (US); David White, Oakland, CA (US); Shaun Bodington, San Leandro, CA (US); Jie Feng, Foster City, CA (US)

(72) Inventors: Ray Olson, Half Moon Bay, CA (US); David White, Oakland, CA (US); Shaun Bodington, San Leandro, CA (US); Jie Feng, Foster City, CA (US)

(21) Appl. No.: 13/586,752

(22) Filed: Aug. 15, 2012

Related U.S. Application Data
(60) Provisional application No. 61/523,784, filed on Aug. 15, 2011.

(51) Int. Cl. G06Q 20/38; G06Q 20/40

(52) U.S. Cl. 705/44; 705/39

(57) ABSTRACT

Embodiments of the present invention include a dynamic and auditable rules-based spend requirement management (SRM) server configured to receive transaction data associated with a payment transaction involving an issuer of an account, where the account is associated with a first set of account level requirements (e.g., a minimum spend requirement) and a first interchange rate. The SRM is further configured to determine that the transaction data is not within the first set of account level requirements, but is within a second set of account level requirements associated with a second interchange rate, and associate the account to the second set of account level requirements by way of a final product identifier stored in a database accessible by a payment processing network (PPN).

### CROSS-REFERENCES TO RELATED APPLICATIONS

This application is a non-provisional of and claims priority to U.S. Provisional Application No. 61/523,784, filed Aug. 15, 2011, entitled “Dynamic Level Assessment,” which is incorporated by reference in its entirety for all purposes.

### BACKGROUND

Payment devices (e.g., credit cards, bank cards, etc.) are ubiquitous in modern commerce and can be used in a variety of applications including retail, transit system access, online commerce, banking, and more. Some banks, known as issuers, offer a portfolio of payment devices in a tiered system, such that lower tiered cards may yield fewer carduser benefits and low interchange rates, and higher tiered cards may yield better carduser benefits and higher interchange rates. Interchange rates are typically payed by merchants during the transaction process.

Some high-tiered payment cards require a certain yearly minimum spend amount for users to maintain benefits associated with the payment card. Conventionally, these requirements are reviewed yearly on a batch-type basis, based on payment card number ranges or Bank Identification Numbers (BIN). If changes are necessary (i.e., payment card upgrades or downgrades), then a new card is typically issued with a new card number. Some cardholders may have a high-tiered card and high interchange rate, but may be far below the minimum spend requirement. In such cases, the high-tiered card may be many months away from the next batch review, resulting in the cardholder improperly enjoying high-tier benefits many months longer than he should. Consequently, subsequent transactions during the pendency prior to the next review will result in merchants unfairly paying incorrect interchange rates. Hence, this invention solves that problem.

### BRIEF SUMMARY

Embodiments of the present invention include a dynamic and auditable rules-based spend requirement management (SRM) server configured to receive transaction data associated with a payment transaction involving an issuer of an account, where the account is associated with a first set of account level requirements (e.g., a minimum spend requirement) and a first interchange rate. The SRM is further configured to determine that the transaction data is not within the first set of account level requirements, but is within a second set of account level requirements associated with a second interchange rate, and associate the account to the second set of account level requirements by way of a final product identifier stored in a database accessible by a payment processing network (PPN).

### BRIEF DESCRIPTION OF THE DRAWINGS

FIG. 1 is a simplified block diagram of a payment authorization system, according to an embodiment of the present invention.

FIG. 2 is a simplified flow diagram illustrating a method for establishing a product portfolio, assigning accounts to one of a plurality of products in the product portfolio, and dynamically reassigning the accounts based on account level requirements, according to an embodiment of the present invention.

FIG. 3 is a simplified flow diagram illustrating a method for assigning an account to a payment product of a plurality of payment products within a product portfolio, according to an embodiment of the present invention.

FIG. 4 is a simplified flow diagram illustrating a method for account level management, according to an embodiment of the present invention.

FIG. 5 is a simplified diagram of a system configured to perform account level management functions, according to an embodiment of the invention.

FIG. 6 is a diagram illustrating aspects of account linking for tracking spend, according to an embodiment of the invention.

FIG. 7 is a diagram of a computer apparatus 700, according to an example embodiment.

### DETAILED DESCRIPTION

Embodiments of the present invention relate to systems and methods for performing a dynamic product level spend assessment in a financial product portfolio.

In certain embodiments, a dynamic and programmable spend requirement manager is configured to receive financial account data from an account database. The account data is assigned to one of a plurality of payment products where each payment product has certain account level requirements. In some embodiments, an account level requirement can be a minimum spend requirement. Each payment product can have an associated interchange rate where the level of interchange is based on the account level requirements of the particular payment product. In certain embodiments, the spend requirement manager determines whether the account data meets the account level requirements of the assigned payment product. If the account data meets the account level requirements, then the account data remains associated with the assigned payment product. If the account data does not meet the account level requirements, then the spend requirement manager reassigns the account data to a new payment product with better matching account level requirements. The spend requirement manager loads a final product identifier into a database, where the final product identifier identifies which of the plurality of payment products the account data is currently assigned to.

Prior to discussing the specific embodiments of the invention, a further description of some terms can be provided for a better understanding of embodiments of the invention.

A “payment device” may include any suitable device capable of making a payment. For example, a payment device can include a card which may be a credit card, debit card, charge card, gift card, or the like. In certain embodiments, a payment device can be a payment product.

A “product portfolio” may include a collection of payment products (e.g., payment devices) offered by an issuer. For example, a product portfolio may include four payment products with a tiered benefits and interchange system where higher tiered payment products yield higher benefits to a customer and higher interchange rate to the issuer. On the other hand, lower tiered products may yield fewer benefits to a customer and a lower interchange rate to the issuer.

“Interchange” may be a fee that is charged to a merchant and paid to an issuer for allowing the use of a payment product at the merchant's place of business. For example, a customer may swipe their credit card (payment product) at a merchant's POS terminal to complete a purchase transaction. The merchant is typically required to pay a certain interchange rate, or fee, to the payment product issuer for each transaction performed at the terminal. Interchange rates typically range from about 0.5%-2% and can vary depending on a variety of factors known by those of ordinary skill in the art. Other interchange rates can be used as required.

A “payment processing network” (e.g., VisaNet™) may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™ in particular, includes a VIP system (Visa Integrated Payments system) which processes authorization requests and a Base II system which performs clearing and settlement services.

An “authorization request message” can include a request for authorization to conduct an electronic payment transaction. It may further include an issuer account identifier. The issuer account identifier may be a payment card account identifier associated with a payment card. The authorization request message may request that an issuer of the payment card authorize a transaction. An authorization request message according to an embodiment of the invention may comply with International Organization for Standardization (ISO) standard 8583, which is a standard for systems that exchange electronic transactions made by cardholders using payment cards.

An “authorization response message” can be a message that includes an authorization code, and may typically be produced by an issuer. A “transaction response” may be an authorization response message in some embodiments of the invention.

A “server computer” can be a powerful computer or a cluster of computers. For example, the server computer can be a large mainframe, a minicomputer cluster, or a group of servers functioning as a unit. In one example, the server computer may be a database server coupled to a Web server.

“Account level requirements” can be a minimum spend requirement for a financial account over a predetermined period of time (e.g., yearly, quarterly, monthly, etc.). For example, certain financial accounts may require an account holder to spend at least $50,000 per year in order to maintain use and benefit of certain perks associated with the account. Other account level requirements may be utilized including velocity (e.g., the number of transactions over a predetermined time period (e.g., one year, one month, etc.)), processing fees (e.g., fees associated with acquirers), average amount per transaction over a predetermined time period, percentage of total purchases made in a given industry, or any other suitable metric that would be appreciated by one of ordinary skill in the art with the benefit of this disclosure.

“Transaction data” can be financial data including a spend history (e.g., listing of purchases over a given period of time), number/type/amount of transactions, data of purchases, average spend over a predetermined period, a user's personal data, user credentials, and the like.

A “terminal” (e.g. a point-of-service (POS) terminal) can be any suitable device configured to process payment transactions such as credit card or debit card transactions, or electronic settlement transactions, and may have optical, electrical, or magnetic readers for reading data from other portable consumer devices such as smart cards, keychain device, cell phones, payment cards, security cards, access cards, and the like.

An “acquirer” is a business entity (e.g., a commercial bank) that typically has a business relationship with the merchant and receives some or all of the transactions from that merchant.

An “issuer” is a business entity which issues a card to a card holder. Typically, an issuer is a financial institution.

In the embodiments described below, “interchange rates” are discussed in detail, however other rates such as processing fee rates (e.g., by payment networks), discount rates, “passthru” rates, add-on rates, and the like, could also be included in embodiments of the invention.

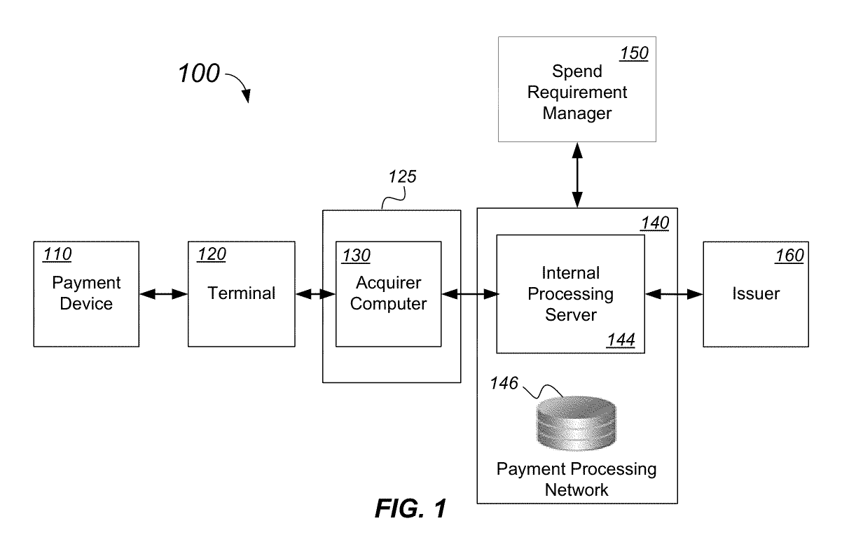

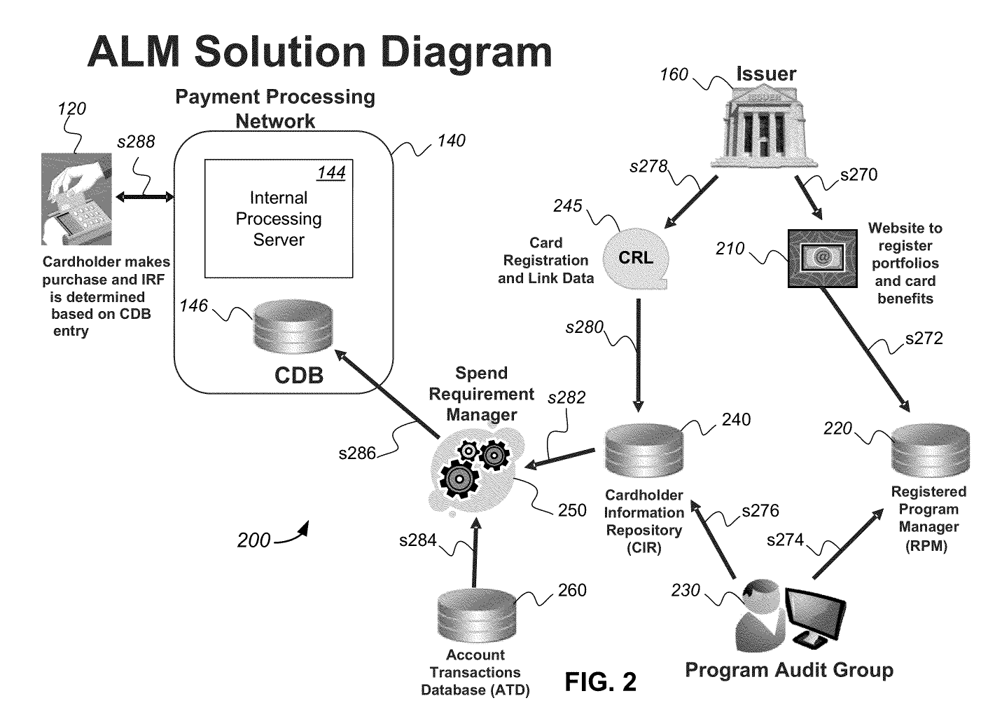

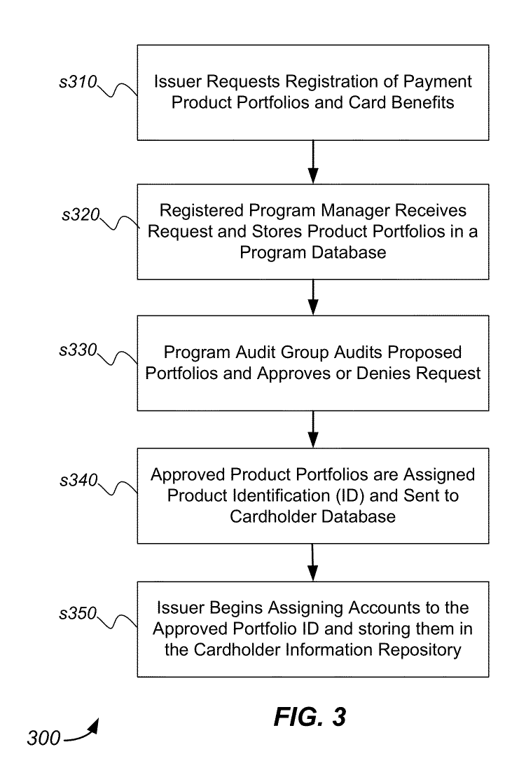

FIG. 1 is a simplified block diagram of a payment authorization system 100, according to one embodiment of the present invention. The system 100 includes a payment device 110, a terminal 120, an acquirer 125, a payment processing network 140, a spend requirement manager 150, and an issuer 160. The acquirer further includes an acquirer computer 130. The payment processing network 140 includes an internal processing server 144 and a final product database 146. The final product database 146 is further discussed below with reference to FIGS. 2-5. In some embodiments, the payment processing network 140 is referred to as a multi-lateral switch. In further embodiments, the spend requirement manager 150 can be located in and controlled by the payment processing network 140. The payment device 110 can also be a payment product, as further described below with respect to FIGS. 2 and 3.

In certain embodiments, a user swipes a payment device 110 (e.g., credit card) at a point-of-service (“POS”) terminal 120 (e.g., at a checkout counter) to make a purchase. The POS terminal 120 can prompt the user to input their payment device data (e.g., bank identification number or “BIN”). The terminal 120 sends the BIN and purchase transaction data (e.g., the authorization request) to an acquirer (e.g., a bank associated with the terminal). The acquirer in turn sends the authorization request to a payment processing network 140 (e.g., VisaNet™). The payment processing network sends the authorization request to the issuer 160 (i.e., the bank that issued the user payment device) to process the authorization request. If the user has enough funds to complete the transaction request, the issuer 160 executes the transaction and sends a message to the terminal 120 that the transaction (e.g., purchase) is authorized. It should be noted that this particular embodiment is but one of many possibilities and permutations of an authorization process which would be known and appreciated by one of ordinary skill in the art with the benefit of this disclosure

In an embodiment, the payment device 110 is in electronic communication with the terminal 120. In certain embodiments, the terminal 120 is operated by a merchant. For example, a coffee shop can have a terminal 120 to swipe a customer's payment card. The payment device 110 may include a credit card, debit card, charge card, or the like. In some embodiments, each time a merchant uses a customer's payment card on their POS terminal 120, a fee is awarded to the issuer 160 that issued that particular payment card. The interchange fee is typically paid by the merchant. The fee can be referred to as an “interchange rate” or an “interchange.” The interchange associated with purchase transactions is discussed below with respect to FIGS. 2-3. The payment device 110 can be a payment product from a payment product portfolio. Payment product portfolios and the payment products therein are further discussed below with respect to FIGS. 2-3.

In other embodiments, the payment device may be used in conjunction with transactions of currency or points (e.g., points accumulated in a particular software application). Alternatively, the payment device may be a personal digital assistant (“FDA”), mobile cell-phone, tablet computer, or the like. In further embodiments, the payment device may be a wireless device, a contactless device, a magnetic device, or other type of payment device that would be known and appreciated by one of ordinary skill in the art with the benefit of this disclosure. In yet further embodiments, a payment device 110 is not needed. For example, the BIN or other identifying information can be provided by other means (e.g., a digital wallet).

The terminal 120 is configured to be in electronic communication with the payment device 110 and acquirer computer 130. In certain embodiments, the terminal is a POS device controlled by a merchant. In an embodiment, the terminal 120 has the capability of reading a magnetic stripe on a traditional credit/debit card (e.g., BIN), or other portable consumer devices, such as a mobile phone, PDA, and the like, through wireless coupling (e.g., Paywave).

The acquirer computer 130 is one component of acquirer 125 (i.e., an acquirer bank), according to an embodiment of the invention. The acquirer computer 130 can be configured to transfer the identification (e.g., PIN, BIN, etc.) and financial information to the payment processing network 140. In some embodiments, the acquirer 125 does not need to be present in the system 100 to transfer the authorization request to the payment processing network 140. In one non-limiting example, the acquiring bank 125 may additionally check the credentials of the user against a watch list in order to prevent fraud and money laundering schemes, as would be appreciated by one of ordinary skill in the art.

In certain embodiments, the payment processing network 140 is configured to communicate with the issuer 160 to effectuate or “authorize” a transaction, and communicate the authorization results back to the user on the terminal 120 (e.g., the merchant POS terminal). In some embodiments, the internal processing server 144 performs the payment authorization functions. Alternatively, the internal processing server 144 can include an authorization and settlement server (not shown) to perform the authorization functions described herein. The internal processing server 144 is further configured to send and receive authorization data to the issuer 160.

The spend requirement manager 150 can be used to track spend characteristics for the payment devices 110 (e.g., payment products) and set interchange rates based on those spend characteristics. The spend requirement manager 150, interchange rates, and spend characteristics are further described below with respect to FIG. 2-5. In one embodiment, the payment processing network 140 is VisaNet™, where Visa internal processing (VIP) performs the various payment processing network 140 (e.g., functions of internal processing server 144) or multi-lateral switch functions described herein.

The issuer 160 can be configured to receive the authorization data from the internal processing server 144. In some embodiments, the issuer 160 receives authentication data from the internal processing server 144 and determines if the user is authorized to perform a given financial transaction (e.g., product purchase).

In certain embodiments, the issuer 160 may consider additional factors in determining whether to authorize the financial transaction. For example, a user's geographic location, a transaction amount, transaction history, or other metrics may be used as would be appreciated by one of ordinary skill in the art with the benefit of this disclosure.

FIG. 2 is a simplified flow diagram illustrating a method 200 for establishing a product portfolio, assigning accounts to one of a plurality of products in the product portfolio, and dynamically reassigning the accounts based on account level requirements, according to an embodiment of the present invention. The method 200 is performed by processing logic that may comprise hardware (circuitry, dedicated logic, etc.), software (such as is run on a general purpose computing system or a dedicated machine), firmware (embedded software), or any combination thereof.

FIG. 2 includes an issuer 160, a registration website 210, a registered program manager 220, a program audit group 230, a cardholder information repository (CIR) 240, card registration and link data (CRL) 245, spend requirement manager 250, a card transactions database 260, a payment processing network 140 and terminal 120. The payment processing network 140 further depicts an internal processing server 144 and a cardholder database 146.

As described above in reference to FIG. 1, the issuer 160 can be configured to receive the authorization data from an internal processing server of a payment processing network to authorize a transaction. The issuer 160 can also issue one or more payment devices (e.g., credit cards, bank cards, etc.) to customers. In some cases, the payment devices are part of a product portfolio where a group of payment device types can be hierarchically tiered. To illustrate, there may be multiple payment products in a given portfolio, with each payment product having tiered cardholder requirements. For example, the lowest tiered payment product of a portfolio may have lower cardholder requirements (e.g., a lower minimum spend requirement), thus yielding a smaller number of benefits to the cardholder. Similarly, the highest tiered payment product may have higher cardholder requirements (e.g., a higher minimum spend requirement), thus yielding more benefits to the cardholder. From a cardholder perspective (e.g., the owner of a particular payment product), higher tiered cards offer greater benefits and rewards from the issuer 160 but may require higher levels of spend. In other words, cardholders that routinely spend (e.g., charge) over a predetermined amount (e.g., greater than $50,000) can be offered the higher tiered payment products, while cardholders routinely spending small amount may only have access to lower tiered cards, according to some embodiments on the invention. Similarly, transactions with higher tiered payment products typically yield higher interchange rates for the issuer 160 than transactions with lower tiered payment products.

Prior to product issuance, an issuer bank 160 will typically have to setup or register the proposed payment product portfolios and card benefits on a payment network website 210. The website 210 can be run on a server, a bank of servers, or other suitable means, and may be operated by a registered program manager (RPM), as discussed below, a payment processing network, a third party, or other suitable entity. In certain embodiments, the payment network is VisaNet™. The issuer 160 submits the payment product requirements for each of the portfolios via the website 210, which can be operated by a registered program manager 220. The website 210 provides one means of registration, but other means may be used as would be appreciated by one of ordinary skill in the art.

The registered program manager 220 database can be a tool and repository for registering and/or storing registration requests by issuers that seek permission to begin issuing proposed financial products (e.g., credit cards) and associated card benefits within a product portfolio. In some embodiments, the registered program manager 220 is configured to help determine if the proposed product portfolios have valid programs and benefits packages, as stipulated and controlled by a program auditing group 230. The registered program manager 220 can be run on a server, a bank of servers, or other suitable means, and may be operated by a payment processing network, a third party program audit group 230, or the like.

The program auditing group 230 is typically tasked with approving or disapproving proposed product portfolios stored and accessible on the registered program manager database 220. The program auditing group 230 may be associated with the payment processing network 140 or third party entity. In some embodiments, VisaNet™ is the program audit group. To better illustrate, the program audit group reviews the various benefits, rewards, and interchange associated with the various payment products in a proposed portfolio. If the program audit group determines that the benefits, rewards, interchange, etc., proposed by the issuer 160 are unacceptable, then the proposed portfolio may be rejected. If the program audit group determines that the benefits, rewards, and interchange proposed by the issuer 160 are acceptable, then the audit group can approve the proposed portfolio such that the issuer 160 can issue payment devices to cardholders under the approved product portfolio. Once approved, the program audit group can assign a product identification (“ID”) to the product portfolio and store it in a cardholder information repository (CIR) 240.

The cardholder information repository (CIR) 240 typically holds at least two pieces of data including what sort of payment device (e.g., card) is the account registered as, and what resulting program or classification was sent to a cardholder database 146 of the payment processing network 150, which is further discussed below. Other information can be stored in the CIR 240 including personal information of the account holder (e.g., name, address, account types, account history, etc.).

Card registration and link data (CRL) 245 can be a means of input or a type of file used by issuers 160 to sending cardholder data to be stored in the cardholder information repository 240. In certain embodiments, the card registration and link data can be a cardholder maintenance file (CMF). Other data types, methods, and delivery systems may be used to send cardholder updates to the CIR 240. For example, the card registration data (e.g., data used for assigning cards to programs) and the delivery of card linking data can be manually or automatically initiated via a user interface (e.g., graphical user interface) and delivered through a transaction system (e.g., payment processing network). Other methods of transferring card registration data can be used, as would be appreciated by those of ordinary skill in the art with the benefit of this disclosure.

The account transactions database 260 can include a spend history for the issued payment devices. For example, once the proposed payment devices are approved and the issuer and program audit group update the CIR 240, a user may start using a particular payment card. Each use of the card (i.e., the spend history) may be stored in the card transactions database 260. Additional information can be stored in the card transaction database including debits, credits, cash advances, or the like. In some embodiments, the account transactions database can be a card transactions database.

The spend requirement manager (SRM) 250 can be a rules-based engine configured to run at any predetermined frequency (e.g., real-time, daily, weekly, monthly, bi-monthly, etc.) to determine if the cardholders are meeting their product (account level) requirements. As described above, the account level requirements can be spend requirements for a particular payment product. For example, if a cardholder has a payment product (e.g., credit card) with a $50,000 minimum spend requirement, the spend requirement manager 150 checks to see if the cardholder is meeting that requirement. If the cardholder is not meeting the minimum spend requirement, then the spend requirement manager can upgrade or downgrade a card as stipulated by a predetermined set of rules. For example, the cardholder may be issued a lower tiered payment product. Optionally, if the cardholder is sufficiently exceeding the minimum spend requirement, then the cardholder may be issued a higher tiered payment product with greater benefits, rewards, and interchange. The rules may dictate how often a spend check is performed for a given region, country, product type, or the like.

To illustrate a typical spend check process, the spend requirement manager 250 is configured to receive account level requirements (e.g., minimum spend) from the cardholder database 240. The spend requirement manager 250 can also be configured to receive a card transaction history (e.g., over the past 90 days) for a cardholder's payment product from the card transactions database 260. In certain embodiments, the spend requirement manager 250 determines whether the cardholder's total spend (e.g., charges to the payment product) meets the minimum requirements for that particular payment product over the specified period of time. As described above, the spend requirement manager 250 may upgrade, downgrade, or maintain the cardholder's assigned payment product (i.e., the product ID) based on the card transaction history. The amount of interchange associated with the cardholder's payment product may also change accordingly. For example, downgrading a cardholder to a lower-tiered payment product may lower the amount of interchange awarded to the issuer 160 per transaction.

The cardholder database (CDB) 146 may be configured to store data, sent by the spend requirement manager 250, to instruct the payment processing network on how to process the card (e.g., what interchange rates to apply to a given transaction). More specifically, the spend requirement manager 250 can be configured to load the final product identifier (ID) for that account in a cardholder database (CDB) 146. For example, a number of payment products may be associated with a product portfolio configured in a multi-tiered hierarchy including payment products with few benefits, low spend requirements and high interchange rates, and payment cards with high benefits, high spend requirements, and low interchange rates. Each payment product within the given product portfolio has a product ID. The “final” product ID, as determined by the spend requirements manager 250, identifies which of the payment products to associate with account. In some cases, the payment product will change, thus yielding changes in interchange rates on that account. In certain embodiments, the CDB 146 operates in conjunction with the clearing and settlement and/or authorization systems of the payment processing network 140. It should be noted that although the “product ID” can be a data field that can be manipulated to the control the transaction processing, other control fields can be used (e.g., qualified indicators, flags, etc.) as would be appreciated by one of ordinary skill in the art with the benefit of this disclosure. It should be further noted that these different approaches can be independent of how these types of data are communicated to the transaction processing systems.

The payment processing network 140 and/or the internal processing server 144, can be configured to communicate with the issuer 160 to effectuate or “authorize” a transaction, and communicate the authorization results back to the user on the terminal 120 (e.g., the merchant POS terminal). In some embodiments, the internal processing server 144 performs the payment authorization functions. The terminal 120, as described above, can be controlled by a merchant, and configured to effectuate a payment by a payment device (e.g., magnetic stripe cards, mobile phones, Paywave, etc.).

Referring to FIG. 2, the method 200 begins with the issuer bank 160 registering proposed payment product portfolios and card benefits on a payment network website (step s270). In certain embodiments, the payment network is VisaNet™. The issuer 160 supplies payment product requirements for each of the portfolios. It should be noted that the registered payment product portfolios are “proposed” at step s270 because the product portfolios have not yet been accepted by the program audit group as described below in step s274.

In some embodiments, once the issuer 160 submits the proposed payment product portfolios, the payment processing network 140 stores the rewards programs and card benefits identified in the product portfolios in the registered program manager database 220 (step s272). The program audit group (step s274) reviews and can reject or allow the proposed portfolio. In some embodiments, VisaNet™ is the program audit group. Once approved, the program audit group assigns a product identification (“ID”) to the product portfolio and stores it in the CIR 240 (step s276).

At step s278, the issuer 160 begins sending accounts to the assigned portfolio ID as CRL files 245 (step 278), which is stored in the CIR 240 database (step 280). The spend check engine 250 receives the spend history (step s284) and the account level requirements for a particular account (step s282) and determines if the given product is meeting its given product requirements (e.g., spend minimum).

The spend requirement manager 250 can operate an any predetermined frequency (e.g., weekly, monthly, bi-monthly, etc.) for any number of account level attributes. For example, the timing and frequency may depend on a country or region that the spend requirement manager is operating in, the type of products used, the amount of spend history on the card, etc., as described above.

The spend check engine 150 loads the final product ID for that account in a final product database 146 (step s286). At step s288, a cardholder makes a purchase with a payment product, and the payment processing network applies the appropriate interchange rate to the transaction based on the final product ID in the cardholder database 146. In various embodiments, some or all of the steps described in FIG. 2 can be performed within the payment processing network 140. For example, each of the RPM 220, CIR 240, SRM 250, and card transaction database 260, or any combination thereof, can be included in the payment processing network 140. Furthermore, the auditing process of step s274 may be performed from within the payment processing network 140. In alternative embodiments, the spend requirement manager can infer the account open date for spend calculation purposes, based on transaction data.

It should be appreciated that the specific steps illustrated in FIG. 2 provides a particular method for setting up a product portfolio and assigning an account to one of a plurality of products in the product portfolio, according to an embodiment of the present invention. Other sequences of steps may also be performed according to alternative embodiments. For example, alternative embodiments of the present invention may perform the steps outlined above in a different order. Moreover, the individual steps illustrated in FIG. 2 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 200.

FIG. 3 is a simplified flow diagram illustrating a method 300 for assigning an account to a payment product of a plurality of payment products within a product portfolio, according to an embodiment of the present invention. The method 300 can be performed by processing logic that may comprise hardware (circuitry, dedicated logic, etc.), software (such as is run on a general purpose computing system or a dedicated machine), firmware (embedded software), or any combination thereof.

Referring to FIG. 3, the method 300 begins with the issuer 160 requesting the registration of one or more payment products in a product portfolio and their associated card benefits (step s310). In some cases, the registration request is performed on a registration website 210. As described above, the product portfolio may be a tiered system of payment cards with varying levels of benefits, spend requirements, and interchange rates.

At step s320, the registered program manager 220 receives the request and stores the product portfolio in a program database. The registered program manager 220 database can be a software tool and repository for registering and/or storing registration requests by issuers that seek permission to begin issuing proposed financial products and associated card benefits within a product portfolio. In some embodiments, the registered program manager 220 is configured to help determine if the proposed product portfolios have valid programs and benefits packages, as stipulated and controlled by a program auditing group 230. The registered program manager 220 can be run on a server, a bank of servers, or other suitable means, and may be operated by a payment processing network, a third party program audit group 230, or the like.

At step 330, the program audit group audits the proposed product portfolios and approves or denies the request. The program auditing group 230 may be associated with the payment processing network 140 (e.g., VisaNet™), or third party entity. If the program audit group determines that the benefits, rewards, and interchange proposed by the issuer 160 are acceptable, then the audit group can approve the proposed portfolio such that the issuer 160 can issue payment devices to cardholders under the approved product portfolio. Once approved, the program audit group can assign a product identification (“ID”) to the product portfolio and store it in a cardholder information repository (CIR) 240 (step s340).

At step 350, the issuer begins assigning accounts to the approved portfolio ID and storing them in the cardholder information repository 240. In some embodiments, the card registration and link data is sent via cardholder maintenance files (CMF) 245.

It should be appreciated that the specific steps illustrated in FIG. 3 provides a particular method for assigning an account to a payment product of a plurality of payment products within a product portfolio, according to an embodiment of the present invention. Other sequences of steps may also be performed according to alternative embodiments. For example, alternative embodiments of the present invention may perform the steps outlined above in a different order. Moreover, the individual steps illustrated in FIG. 3 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 300.

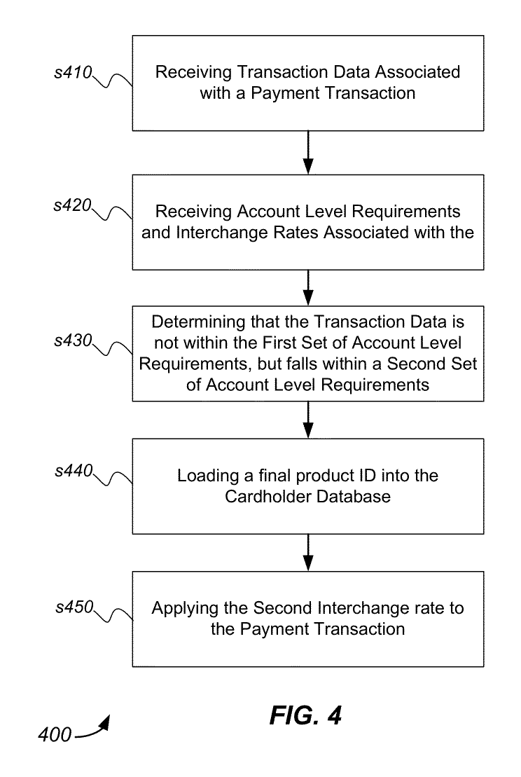

FIG. 4 is a simplified flow diagram illustrating a method 400 for account level management, according to an embodiment of the present invention. The method 400 is performed by processing logic that may comprise hardware (circuitry, dedicated logic, etc.), software (such as is run on a general purpose computing system or a dedicated machine), firmware (embedded software), or any combination thereof. In certain embodiments, the method 400 is performed by the spend requirement manager 250 of FIG. 2.

Referring to FIG. 4, the method 400 begins with receiving, at a server computer, transaction data associated with a payment transaction involving an issuer of an account (step s410). In some embodiments, the transaction data can be a spend history associated with a payment product used in the payment transaction, where the payment product was issued by the issuer. The spend history may be any suitable interval of time (e.g., spend history for the past month, year, etc.). In some cases, the spend requirement manager 250 requests the transaction data from the card transactions database 260 of FIG. 2.

At step 420, the spend requirement manager 250 receives a set of account level requirements associated with the payment product. The account level requirements can include a minimum spend requirement and an associated interchange rate. For example, a high-tiered payment card may require a minimum spend of $50,000 per year, but can yield high-level card benefits and low interchange rates.

At step 430, method 400 further includes determining that the transaction data is not within the first set of account level requirements, but is in a second set of account level requirements associated with a second interchange rate. For example, if the account requires a $50,000/year spend (i.e., the first set of account level requirements), but falls short of that spend minimum, the spend requirement manager 250 can determine a second set of account level requirements and associated interchange rates to apply to the account to better match the current and/or predicted spend for that year or any predetermined interval.

At step s440, the spend requirement manager loads the final product identifier into the cardholder database 146. The final product identifier can identify the appropriate interchange rate to apply to subsequent transaction to the account. At step s450, the payment processing network accesses the final product ID from the cardholder database 146, applies the new interchange rate, and completes the transaction (i.e., sends an authorization response to the terminal 120). It should be noted that other account data may be included in the final product ID including, but not limited to, a product type or characterization (i.e., Visa Signature, Visa Signature Preferred, etc.), associated benefits or account perks (e.g., miles points, special vendor discounts, etc.), or other account level requirements that would be appreciated by one or ordinary skill in the art. In alternative embodiments, the spend requirement manager can enforce spend minimums on accounts without the need for issuer card registration. This can be referred to as “auto registration.”

It should be appreciated that the specific steps illustrated in FIG. 4 provides a particular method for account level management, according to an embodiment of the present invention. Other sequences of steps may also be performed according to alternative embodiments. For example, alternative embodiments of the present invention may perform the steps outlined above in a different order. Moreover, the individual steps illustrated in FIG. 4 may include multiple sub-steps that may be performed in various sequences as appropriate to the individual step. Furthermore, additional steps may be added or removed depending on the particular applications. Further still, the spend requirement manager 250 may be located and controlled by the payment processing network, such that some or all of the steps of method 400 are performed therein. Furthermore, although FIG. 4 illustrates a simple pass/fail scenario with respect to determining account level requirements, there can be tiers of rules such that there can be multiple spend thresholds. For example, if a cardholder with a high-tiered business card with a 50K spend requirement spends less than a first threshold (e.g., 40K) but more than a second threshold (e.g., 10K), the payment card may get downgraded to a mid-tier level. If the cardholder spends less than the second threshold (e.g., 10K), then the payment card can get downgraded to a low-tiered level. One of ordinary skill in the art would recognize and appreciate many variations, modifications, and alternatives of the method 400.

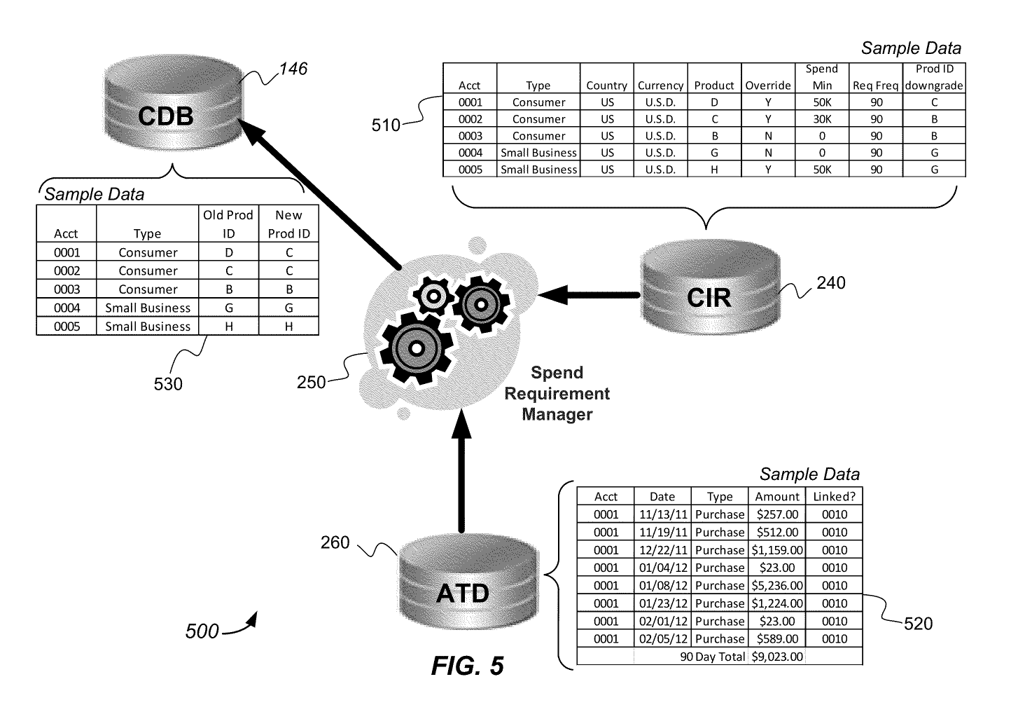

FIG. 5 is a simplified diagram of a system 500 configured to perform account level management functions, according to an embodiment of the invention. The system includes a spend requirement manager 250, a cardholder information repository 240, an account transaction database 260, and a cardholder database 146. The CIR 240 contains data 510 (e.g., account level requirements) associated with a number of accounts. The ATD 260 contains transaction data associated with a number of accounts. The CDB 146 contains final product ID's associated with a number of accounts.

The cardholder information repository (CIR) 240 typically holds at least two pieces of data including what sort of payment device (e.g., card) the account is registered as, and what resulting program or classification was sent to a cardholder database 146 of the payment processing network 150. Other information can be stored in the CIR 240 including personal information of the account holder (e.g., name, address, account types, account history, etc.). Table 510 depicts one example of some of the types of information that may be stored in the CIR 240. Some embodiments include the various account numbers and associated issuers (not shown), the type of payment product user (e.g., consumer, small business, corporate, etc.), the country of issuance, the currency type associated with the account, the product identifier (e.g., Visa Signature (C), Visa Signature Preferred (D), etc.), spend requirement override capabilities, a minimum spend requirement, frequency of spend assessment, and the product ID after a downgrade. Many other account attributes and requirements can be included as would be appreciated by one of ordinary skill in the art with the benefit of this disclosure. It should be noted that these attributes (i.e., rules) are fully customizable by a program audit group, entities controlled by, or associated with, the payment processing network, or other suitable third party entity.

The account transactions database (ATD) 260 can include a spend history for issued payment devices for a particular account. Each use of the card (i.e., card transactions) may be stored in the card transactions database 260. Additional information can be stored in the card transaction database including debits, credits, cash advances, or the like. In some embodiments, the account transactions database can be a card transactions database. Table 520 depicts a sample of some of the data that can be collected in the ATD 260, including the account name, the type of transactions, the date of the transactions, the amount of the transactions, and whether or not a particular account number is associated, or linked, to another account number or product device, as further discussed below.

The cardholder database (CDB) 146 can be configured to store data, sent by the spend requirement manager 250, to instruct the payment processing network on how to process the card (e.g., what interchange rates to apply to a given transaction). More specifically, the spend requirement manager 250 can be configured to load the final product identifier (ID) for that account in a cardholder database (CDB) 146. Each payment product within the given product portfolio has a product ID. The “final” product ID, as determined by the spend requirements manager 250, identifies which of the payment products to associate with account. Table 530 depicts some of the types of data that may be stored in the CDB 146, according to certain embodiments of the invention. For example, the CDB 146 may store account numbers, account types (e.g., consumer, small business, corporate, etc.), the old product ID originally assigned to the account, and the new product ID as determined by the spend requirement manager 250.

In operation, the spend requirement manager (SRM) 250 can be a rules-based engine configured to receive account level requirements (e.g., minimum spend) from the CIR 240. Referring to Table 510, account 0001 has a product classification of “D” with a $50,000 minimum spend requirement and a frequency of spend assessment set to 90 days. The spend requirement manager 250 may also be configured to receive a card transaction history for a cardholder's payment product from the card transactions database 260. Referring to Table 520, account 0001 has a total of 8 transactions amounting to $9023 of total spend over a 90-day period, as stipulated per the account level requirements of the CIR 240. The spend requirement manager 250 determines whether the cardholder's total spend (e.g., charges to the payment product) meets the minimum requirements for that particular payment product over the specified period of time. Based on the data from tables 510 and 520, the spend requirement manager 250 determines whether $9023 of spend history over a 90-day period is sufficient to maintain the current product ID and its associated benefits and interchange rate. As described above, the spend requirement manager 250 may upgrade, downgrade, or maintain the cardholder's assigned payment product (i.e., the product ID) based on the card transaction history and the associated account level requirements or attributes, and load the new or final product identifier in the CDB 146. Referring to Table 530, account 0001 was previously set as a type “D” account (e.g., with 1.25% interchange), but has been downgraded to a type “C” account (e.g., 1% interchange). As such, each subsequent transaction with the account will be processed as a type “C” account and may result in lower interchange rates and fewer benefits, depending on the product portfolio defined during the initial registration process.

Some payment devices or accounts may include an override feature that provides a “grace” period for cardholder not meeting their spend requirements. For example, some accounts may allow 90 days after it is determined that a spend minimum is not being met to provide the cardholder an opportunity to appropriately increase their total spend. Any predetermined grace period or application of such override features may be implemented as necessary.

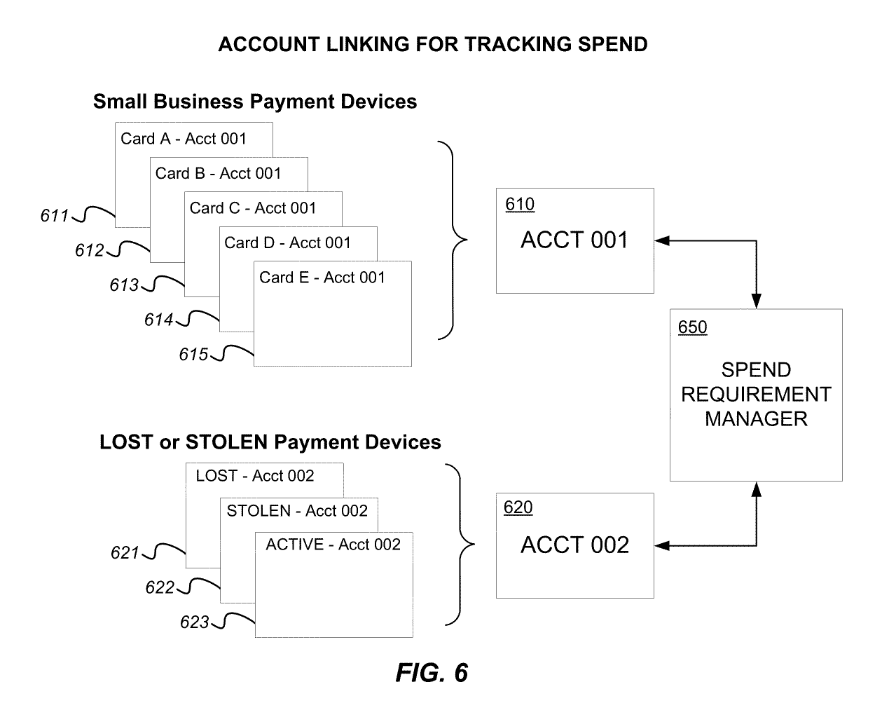

FIG. 6 is a diagram illustrating aspects of account linking for tracking spend, according to an embodiment of the invention. FIG. 6 includes account 001 (610), account 002 (620), and a spend requirement manager 650. Account 001 can be a small business account and can be associated with a number of payment devices including card A (611), card B (612), card C (613), card D (614), and card E (615). Account 002 can be consumer level account associated with a lost card 621, a stolen card 622, and an active card 623. The data associated with account 001 and account 002 can be accessible by the spend requirement manager 650. In some embodiments, the data in accounts 001 and 002 may be stored in the cardholder database.

When tracking spend, there typically is a need to keep track of spend records over a long period of time. Sometimes credit cards can get lost or stolen and new cards are issued with new account numbers. As shown in FIG. 6, an account holder for account 002 lost a card 621, had a new issued card stolen 622, and currently uses a newly activated card 623. Conventionally, each account number would have its own spend history during the life of its use and there would not be any means of linking them for an accurate spend assessment. For example, if a user used card 622 to make a high dollar purchase prior to it being stolen, then a subsequent spend check for the active card 623 would not reflect this purchase, or any other purchase (i.e., spend history) that may have occurred prior to activation of the active card 623. With the advent of account linking, as newly presented herein, the spend histories associated with card numbers 621, 622, and 623 can be aggregated and associated with a single account (e.g., Account 002), such that the spend requirement manager 650 can access an accurate spend history accumulated by the user over the three cards 621, 622, and 623.

Account linking can also apply to business accounts. For example, a business may issue many different cards (A-E) to several different departments for accounting purposes. With account linking, the present invention supports the ability to group the cards (A-E) into line of credit or customer groupings, such that the spend histories of each card is aggregated and associated with a single account. Thus, by accessing a single account, the spend requirement manager 650 can track total spend across the group of cards (A-E). In some embodiments, spend rules may be associated with a business rather than individual cards. As such, the spend requirement manager 650 can apply the rules associated with the business rather than the rules associated with the individual cards.

In alternative embodiments, some cards or payment devices automatically track to a card to which it is linked such that any changes to the processing status of the “primary” linked card will be automatically reflected in the “secondary” linked card.

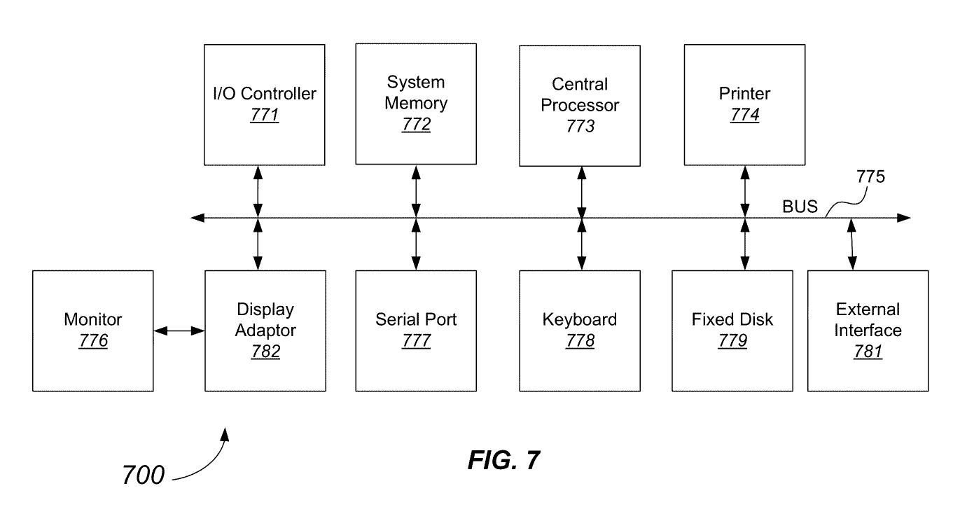

FIG. 7 is a diagram of a computer apparatus 700, according to an example embodiment. The various participants and elements in the previously described system diagram (e.g., the payment processing network, acquiring bank, issuing bank, etc. in FIG. 1) may use any suitable number of subsystems in the computer apparatus to facilitate the functions described herein. Examples of such subsystems or components are shown in FIG. 7. The subsystems shown in FIG. 7 are interconnected via a system bus 775. Additional subsystems such as a printer 774, keyboard 778, fixed disk 779 (or other memory comprising computer-readable media), monitor 776, which is coupled to display adapter 782, and others are shown. Peripherals and input/output (I/O) devices (not shown), which couple to I/O controller 771, can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus allows the central processor 773 to communicate with each subsystem and to control the execution of instructions from system memory 772 or the fixed disk 779, as well as the exchange of information between subsystems. The system memory 772 and/or the fixed disk 779 may embody a computer-readable medium.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

In embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents. Furthermore, embodiments of the invention can solve the problems described herein as well as other problems.

What is claimed is:

1. A method comprising:
receiving at a server computer, transaction data associated with a payment transaction involving an issuer of an account, the account being associated with a first set of account level requirements and a first rate;
determining that the transaction data is not within the first set of account level requirements, but is in a second set of account level requirements associated with a second rate; and
applying the second rate to the payment transaction.

2. The method of claim 1 wherein the first and second account level requirements each include a minimum spend requirement for the account.

3. The method of claim 1 further comprising associating the account to the second set of account level requirements with the second rate and storing the association of the account to the second set of account level requirements in a database accessible by a payment processing network, wherein the payment processing network is configured to perform the applying the second rate to subsequent payment transactions with the account.

4. The method of claim 3 wherein storing the determination further includes loading a final product identifier into the database accessible by the payment processing network, wherein the final product identifier identifies which of the account level requirements the account is assigned to.

5. The method of claim 1 wherein the determining is performed at a customizable predetermined frequency.

6. The method of claim 1 wherein if the transaction data does not satisfy the account level requirements of the account and the transaction data includes a spend history of less than a predetermined period, the method includes applying an exception to the payment transaction such that the first rate is maintained during the predetermined period.

7. The method of claim 1 wherein the first set of account level requirements and the first rate are associated with a first payment product, and the second set of account level requirements and the second rate are associated with a second payment product, wherein the first rate and the second rate are interchange rates.

8. A server computer comprising:
a processor and a computer-readable storage medium coupled to the processor, the computer-readable storage medium comprising code executable by the processor for implementing a method comprising:
receiving at a server computer, transaction data associated with a payment transaction involving an issuer of an account, the account being associated with a first set of account level requirements and a first rate;
determining that the transaction data is not within the first set of account level requirements, but is in a second set of account level requirements associated with a second rate; and
applying the second rate to the payment transaction.

9. The server computer of claim 8 wherein the first and second account level requirements each include a minimum spend requirement for the account.

10. The server computer of claim 8 wherein determining further includes:
further comprising associating the account to the second set of account level requirements with the second rate and storing the association of the account to the second set of account level requirements in a database accessible by a payment processing network, wherein the payment processing network is configured to perform the applying the second rate to subsequent payment transactions with the account.

11. The server computer of claim 8 wherein storing the determination further includes loading a final product identifier into the database accessible by the payment processing network, wherein the final product identifier identifies which of the account level requirements the account is assigned to.

12. The server computer of claim 8 wherein the determining is performed at a customizable predetermined frequency.

13. The server computer of claim 8 wherein if the transaction data does not satisfy the account level requirements of the account and the transaction data includes a spend history of less than a predetermined period, the method includes applying an exception to the payment transaction such that the first rate is maintained during the predetermined period.

14. The server computer of claim 8 wherein the first set of account level requirements and the first rate are associated with a first payment product, and the second set of account level requirements and the second rate are associated with a second payment product, wherein the first rate and the second rate are interchange rates.

15. A method of account level management performed by a payment processing network, the method comprising:
receiving a request to authorize a payment transaction associated with a payment device issued by an issuer, wherein the payment device is associated with a financial account;
receiving from a first database, a spend history for the financial account;
receiving from a second database, the first set of account level requirements associated with the financial account, wherein the first set of account level requirements is associated with a first interchange rate;
determining that the spend history for the financial account does not satisfy the first set of account level requirements, but does satisfy a second set of account level requirements, wherein the second set of account level requirements is associated with a second interchange rate;
performing the authorization using the second interchange rate.

16. The method of claim 15 wherein the first and second account level requirement each include a minimum spend requirement for the financial account.

17. The method of claim 15 further including updating the second database to reflect that the second account level requirements are associated with the financial account.

18. The method of claim 15 wherein the second database is audited and updated at a predetermined frequency based on a customizable rules based criteria.

19. The method of claim 18 wherein the rules based criteria includes at least one of a location of the issuing entity, a location of the transaction, type of currency associated with the financial account, or a payment device type.

20. The method of claim 15 wherein if the spend history does not satisfy the first set of account level requirements but spans less than a predetermined period, applying an exception to the payment transaction such that the first interchange rate is maintained during the predetermined period.
